(19) United States
(12) Patent Application Publication
(10) Pub. No.: US 2010/0318827 A1
(43) Pub. Date: Dec. 16, 2010

(54) ENERGY USE PROFILING FOR WORKLOAD TRANSFER

(75) Inventors: Shon Shah, Redmond, WA (US); Mark R. Aggar, Mercer Island, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/484,473

(22) Filed: Jun. 15, 2009

(51) Int. Cl. G06F 9/46; G06F 1/32

(52) U.S. Cl. 713/324; 718/105

(57) ABSTRACT

Embodiments of energy profiling for workload transfer are disclosed. In accordance with at least one embodiment, the energy profiling for workload transfer includes determining a baseline wattage of a first server. Further, a load wattage of a workload is derived using a difference between the baseline wattage consumption and an overall wattage consumption. The workload is transferred to a second server when the load wattage is less than an available wattage on the second server.

### BACKGROUND

A server cluster is a collection of computer servers. Server clusters may be maintained by businesses to provide data over a network infrastructure, such as the Internet. In some instances, the servers in a server cluster may implement virtual machines (VM) that execute programs and process data. Moreover, the servers in a server cluster may have varying wattage consumptions under different workload conditions.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Described herein are embodiments of various techniques for determining the energy consumptions of workloads that are running on multiple servers, and transferring workloads between servers based on the determination. The plurality of servers may be part of a server cluster that resides in a data center. The transfer of workloads between the multiple servers during times of low energy consumption may enable the consolidation of multiple workloads and the powering down of one or more servers to conserve energy. In this way, the data center may realize significant energy savings and cost reduction during times of low workload demand.

In at least one embodiment, the energy profiling for workload transfer includes determining a baseline wattage of a first server. Further, a load wattage of a workload is derived using a difference between the baseline wattage consumption and an overall wattage consumption. The workload is transferred to a second server when the load wattage is less than an available wattage on the second server. Other embodiments will become more apparent from the following detailed description when taken in conjunction with the accompanying drawings.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a block diagram that illustrates an exemplary scheme for determining the energy consumption of a workload on a server for the transfer of the workload to a different server, in accordance with various embodiments.

FIG. 2 is a block diagram that illustrates exemplary confidence ratings for determined energy consumption of a workload on a server, in accordance with various embodiments of energy use profiling for workload transfer.

FIG. 3 is a block diagram that illustrates exemplary utilization state classification for determining energy consumption of a workload on a server, in accordance with various embodiments of energy use profiling for workload transfer.

FIG. 4 is a block diagram that illustrates the use of exemplary metrics of a plurality of candidate servers to select a candidate server to accept a transfer workload, in accordance with various embodiments of energy use profiling for workload transfer.

FIG. 5 shows a block diagram that illustrates selected components of a load balance application, in accordance with various embodiments of energy use profiling for workload transfer.

FIG. 6 shows a flow diagram illustrating an exemplary process for transferring a workload from a first server to a second server based on determined workload energy consumption, in accordance with various embodiments of energy use profiling for workload transfer.

FIG. 7 shows a flow diagram illustrating an exemplary process for transferring a workload from a first server to a second server based on determined workload energy consumption and related confidence rating, in accordance with various embodiments of energy use profiling for workload transfer.

FIG. 8 shows a flow diagram illustrating an exemplary process for transferring a workload from a first server to a second server that is selected based on performance metrics, in accordance with various embodiments of energy use profiling for workload transfer.

FIG. 9 shows a block diagram illustrating a representative computing device on which energy use profiling for workload transfer, in accordance with various embodiments, may be implemented.

### DETAILED DESCRIPTION

This disclosure is directed to energy profiling for the transfer of workloads between a plurality of servers. The plurality of servers may be part of a server cluster that resides in a data center. The load wattage of a workload running on each server may be determined as the difference between a baseline wattage consumption of a server and the overall wattage consumption of the server at a time when the workload is running. The load wattage may be determined dynamically and opportunistically. Additionally, a confidence rating may be derived for the determined load wattage to indicate the reliability of the determination. Based on the load wattage of the workload, as well the confidence rating, a load balance application may make decision as to whether the workload is to be transferred to another server. Once the workload is transferred, the server that is previously running the workload may be powered down to save energy. In some embodiments, multiple load wattages and confidence ratings may be determined for different utilization states to further enhance the ability of the load balance application to balance the workloads.

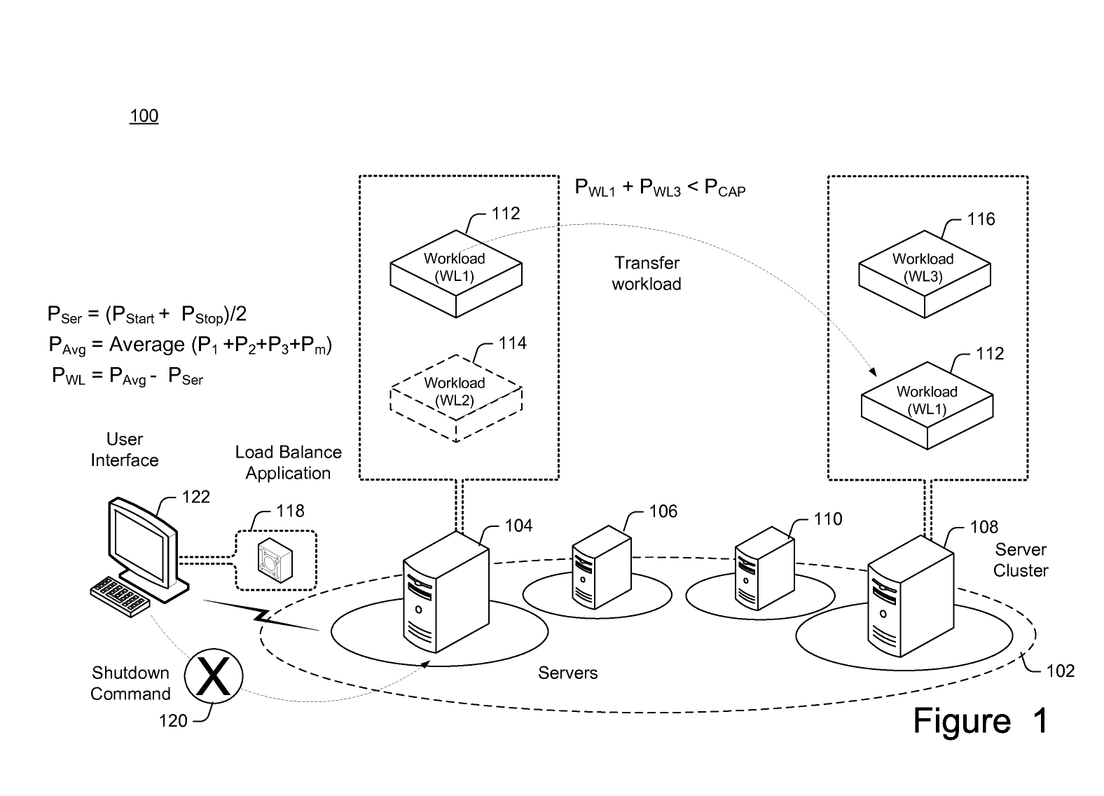

The transfer of workloads between the multiple servers during times of low energy consumption may enable the consolidation of multiple workloads and the powering down of one or more servers to conserve energy. In this way, the data center may realize significant energy savings and cost reduction during times of low workload demand. Various examples of energy profiling for the transfer of workload in accordance with the embodiments are described below with reference to FIGS. 1-9.

### Exemplary Scheme

FIG. 1 is a block diagram that illustrates an exemplary scheme 100 for determining the energy consumption of a workload on a server for the transfer of the workload to a different server, in accordance with various embodiments. The exemplary scheme 100 may include a server cluster 102, which may be part of a data center. The server cluster 102 may include a plurality of servers, such as servers 104-110, which are interconnected via a network infrastructure (e.g., local area network). Moreover, the server cluster 102 may be connected to the outside world via a global network infrastructure (e.g., Internet).

Each of the servers 104-110 may run one or more workloads. The workloads may include the execution of one or more software applications. In various embodiments, the workloads may include the execution of line of business (LOB) software applications. In other embodiments, the workloads may also include database and communication applications such as a Structured Query Language (SQL) database or Microsoft Exchange Server, as developed by the Microsoft Corporation of Redmond, Wash. The workloads may further include virtual machines (VM), or software implementations of machines that execute program applications. In additional embodiments, the workloads may also include virtual hard disks (VHD). As illustrated in FIG. 1, the server 104 may run a workload 112 (WL1) and/or a workload 114 (WL2), and the server 108 may run a workload 116 (WL3). In various embodiments, each of the servers 104-110 may have a wattage capacity that represents the amount of work that each server is able to perform reliably given the system hardware and software configuration of each server.

The exemplary scheme 100 may further include a load balance application 118, which may be part of an operating system. The load balance application 118 may derive the load wattage, i.e., wattage consumption of a workload that is running on each server.

In various embodiments, the load balance application 118 may obtain a measurement, Pₛₜₐᵣₜ, of the wattage consumption of a server, such as server 104, when the server is powered on and idle (i.e., not running any workloads). Second, the load balance application 118 may obtain measurements, such as P_{1,} P_{2,} P_{3,} . . . Pₘ, as the server 104 is running a workload, such as the workload 112 (WL1). Third, the load balance application 118 may obtain an additional measurement, Pₛₜₒₚ, of the wattage consumption of the server, such as server 104, when the server is once again idle and no longer running the workload 112 (WL1). In at least one embodiment, an operating system running on the server may monitor the various machine states of the server 104. Thus, the load balance application 118 may obtain wattage measurements by interfacing with the operating system. In other embodiments, the load balance application 118 may obtain these measurements directly from one or more hardware components of the server.

Accordingly, the load balance application 118 may calculate the baseline power consumption, Pₛₑᵣ, of a server, such as the server 104, using the following:

$${P}_{Ser} = \frac{( {P}_{start} + {P}_{stop} )}{2} \qquad ( 1 )$$

Moreover, the load balance application 118 may further calculate overall wattage consumption, P_{avg}, when the server, such as the server 104, is running a workload, such as the workload 112 (WL1), as follows:

P_{Avg}=Average(P₁+P₂+P₃. . . Pₘ) (2)

Further, the load wattage of the workload, such as the workload 112 (WL1), as represented by P_{WL}, may be calculated as follows:

P_{WL}=P_{Avg}−P_{Ser} (3)

In some embodiments, the load balance application 118 may dynamically perform the power consumption measurements and load wattage calculations for each workload. In other words, the load balance application 118 may automatically perform the measurements and calculation based on the activities of each server and the workloads running on the servers without user input or intervention.

The load balance application 118 may also opportunistically perform the power consumption measurements and load wattage calculations for each workload. In other words, the load balance application 118 may be configured to take power consumption measurements for each workload when it is the only workload running on a server. For example, in the instance of server 104 shown in FIG. 1, the load balance application 118 may obtain the measurements, such as P_{1,} P_{2,} P_{3, . . .} Pₘ, when the server 104 is only running a workload 112 (WL 1). However, the load balance application 118 may cease to obtain wattage measurements when server 104 begins to simultaneously run the secondary workload 114 (WL2). Moreover, the load balance application 118 may resume obtaining the wattage measurements when the server 104 ceases to run the workload 114 (WL2).

It will be appreciated that the servers, such as the server 104, may be designed to run only a single dominate workload on a continuous basis. Thus, the disruption caused by one or more secondary workloads, such as the workload 114 (WL2), may occur infrequently. In this way, the load balance application 118 may ascertain the load wattages of every workload on each server.

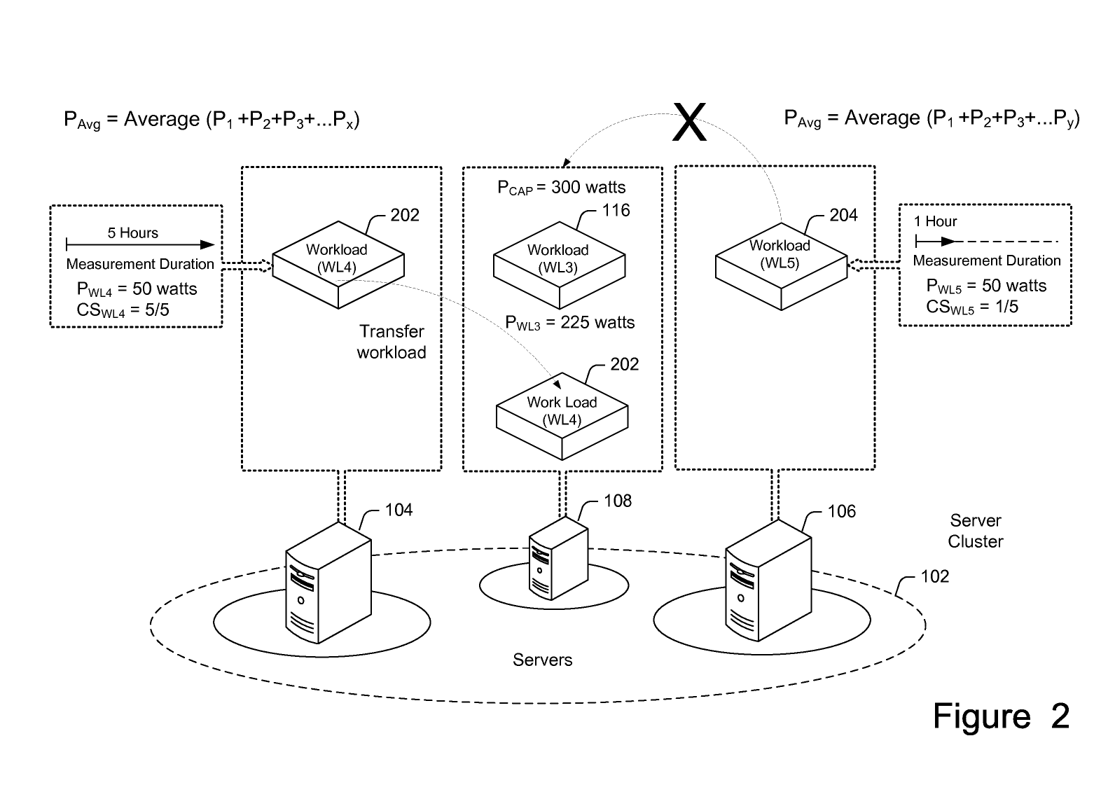

However, in some embodiments, the load balance application 118 may not cease the taking of wattage measurements when the server 104 begins to simultaneously run secondary workload 114 (WL2) if the load wattage of the workload 114 (WL2) is historically constant. For example, but not as a limitation, the load balance application 118 may be able to estimate with a high degree of confidence (e.g., at least 4/5 confidence rating as further described below) that the load wattage of the workload 114 (WL2) at the time of a wattage measurement, P₁, is 40 watts. In such an instance, the load balance application 118 may simply account for the simultaneous load wattage of the workload 114 (WL2) by subtracting 40 watts from P₁ as follows: P₁=P₁−40. In various embodiments, as further described below in FIG. 2, the degree of confidence with respect to the load wattage of a workload may positively correlate the amount of historical wattage measurements accrued by the load balance application 118 for the workload.

While the dynamic and the opportunistic measurements of power consumption and calculation of load wattage have been described with respect to server 104, it will be appreciated that the same measurements and calculations may be implemented for any server and workload. For example, but not as a limitation, the load balance application 118 may also determine the load wattage for the workload 116 (WL3) running on the server 108 by using the dynamic and opportunistic power consumption measurements and load wattage calculations.

The load balance application 118 may take the wattage measurements and calculate the load wattage of a workload, such as the workload 112 (WL1), over a time interval as a server, such as the server 104, continuously executes the workload. By calculating the load wattage of a workload over a time interval, the load balance application 118 may accumulate sufficient data to derive the load wattage of the workload for different time periods, such as the load wattage for different portions of the day, week, month, year, etc.

For example, but not as a limitation, the accumulated data may enable the load balance application 118 to determine that the load wattage of a workload, such as the workload 114 (WL2), may be 100 watts between 8:00 a.m. to 4:00 p.m., 50 watts from 4:00 p.m. to midnight, and 25 watts from midnight to 8:00 a.m. In another example, the accumulated data may enable the load balance application 118 to determine that the load wattage of a workload, such as the workload 116 (WL3), is 150 watts for the majority of each month, yet increases to 250 watts on the last day of each month. As further described, the load balance application 118 may store the load wattages of workloads over a plurality of time intervals, or load wattage histories, into a database.

The load balance application 118 may dynamically transfer workloads between servers 104-110 based on the determined load wattage. In various embodiments, the load balance application 118 may transfer workloads from a first server to a second server based on the determined load wattage, provided that the second server has sufficient wattage capacity to accept the transferred workload. The transfer of a workload from a first server to a second server may enable the load balance application 118 to power down the first server for the purpose of conserving energy.

For example, but not as a limitation, the server 108 may have a total wattage capacity, or P_{cap}, of 300 watts. The workload 116 (WL3) may consume a load wattage, or P_{WL3}, of 200 watts over a time interval. The workload 112 (WL1) running on server 104, may consume a load wattage, or P_{WL1}, of 50 watts over the same time interval. Thus, the load balance application 118 may determine that since P_{WL1}+P_{WL3}<P_{CAP}, the load balance application 118 may move the workload 100 (WL1) from the server 104 to the server 108.

Once a workload has been transferred from a first server to a second server, the load balance application 118 may provide a shutdown command 120 to power down the first server, such as the server 104. The shutdown command 120 may place the first server in a suspended state, so that the first server may quickly resume an active state to run the workload (e.g., workload 112) when needed without rebooting.

In some embodiments, the load balance application 118 may consider a server that is accepting the transferred workload to have sufficient wattage capacity to accept the transfer if the total wattage of one or more workloads already running on a server and the workload to be transferred would not exceed the total wattage capacity of the accepting server. In the context of an example involving servers 104 and 108, these embodiments may be represented as:

P_{WL1}+P_{WL3}<P_{CAP} (4)

In other embodiments, the load balance application 118 may consider a server that is accepting the transferred workload to have sufficient wattage capacity to accept the transfer when the total wattage of one or more workloads already running on a server, the workload to be transferred, and a buffer wattage capacity (e.g., 5-10% of the overall wattage capacity of the accepting server), or P_{Buffer} would not exceed the total wattage capacity of the accepting server. Once again, in the context of an example involving servers 104 and 108, these embodiments may be represented as:

P_{WL1}+P_{WL3}+P_{Buffer}≦P_{CAP} (5)

The buffer wattage capacity may provide a margin of safety to ensure that the accepting server is not overloaded. The load balance application 118 may dynamically and continuously perform these assessments of load wattage and wattage capacity for the servers 104-110 of the server cluster 102 so that workloads may be transferred between them.

Although the load balance application 118 may manage the transfer of workloads, the load balance application 118 may nevertheless be configured to enable a user to monitor the status of the servers, workload transfers, and/or override workload transfers as needed. Accordingly, the user may access the load balance application 118 via the user interface 122. In various embodiments, the user interface 122 may include a data output device such as a display, and one or more data input devices. The data input devices may include, but are not limited to, combinations of one or more of keypads, keyboards, mouse devices, touch screens, microphones, speech recognition packages, and any other suitable devices or other electronic/software selection methods. While server cluster 102 is illustrated as including servers 104-110, the server cluster 102 may include any plurality of servers that run workloads in other embodiments.

FIG. 2 is a block diagram that illustrates exemplary confidence ratings for determined energy consumption of a workload on a server, in accordance with various embodiments of energy use profiling for workload transfer. The servers 104-108 of the server cluster 102 shown may be same as described in FIG. 1.

In various embodiments, the load balance application 118 (FIG. 1) may assign confidence ratings based on the number of wattage measurements obtained for each workload during a specified time period. In some embodiments, the ratings may be in the form of ratios. For example, but not as a limitation, a workload 202 (WL4) running on the server 104 may have a load wattage of 50 watts. As previously described, the load wattage of 50 watts may be obtained in part based on:

P_{Avg}=Average(P₁+P₂+P₃. . . Pₓ) (6)

for which P_{1,} P_{2,} P_{3, . . .} Pₓ, are the wattage measurements obtained as the server 104 is running the workload 202 (WL4).

Likewise, a workload 204 (WL5) running on the server 106 may also have a load wattage of 50 watts. The load wattage of 50 watts may also be obtained in part based on:

P_{Avg}=Average(P₁+P₂+P₃. . . P_{y}) (7)

for which P_{1,} P_{2,} P_{3, . . .} P_{y} are the wattage measurements obtained as the server 106 is running the workload 204 (WL5). In this example, the number of wattage measurements obtained for workload 202 (WL4) during a time period, as represented by P_{1,} P_{2,} P_{3, . . .} Pₓ, may be approximately five times as many as the number of wattage measurements for workload 204 (WL5), as represented by P_{1,} P_{2,} P_{3, . . .} P_{y,}. Accordingly, as shown, the load application 118 may assign a confidence rating of 5 out of 5, or CS_{WL4}=5/5, to the load wattage for workload 202 (WL4), and only assign a confidence rating of 1 out of 5, or CS_{WL5}=1/5, to the load wattage for workload 204 (WL5).

The variability in the load wattage of a workload may be captured more accurately by a higher number of measurements than a lower number of measurements. In other words, a higher number of wattage measurements may provide a greater “resolution” than a lower number of wattage measurements so that the variability in the load wattage of the workload may be more accurately captured and taken into account. Thus, the greater the confidence rating, the less likely that the load wattage of a workload is to vary unexpectedly.

In other embodiments, the load balance application 118 (FIG. 1) may assign confidence ratings based on the length of the time period during which wattage measurements were obtained, regardless of the number of measurements. For example, in the instance that the load wattage of the workload 202 (WL4) may be obtained in part based on:

P_{Avg}=Average(P₁+P₂+P₃. . . Pₓ) (8)

the wattage measurements P₁, P₂, P₃, . . . P_{y}, may be obtained as the server 104 is running the workload 202 (WL4) over a time interval of 5 hours.

Likewise, in the instance that the load wattage of the workload 204 (WL5) may be obtained in part based on:

P_{Avg}=Average(P₁+P₂+P₃. . . P_{y}) (9)

the wattage measurements P_{1,} P_{2,} P_{3, . . .} P_{y} may be obtained as the server 106 is running the workload 202 (WL4) over a time interval of 1 hour. Thus, as shown, the load application 118 may assign a confidence rating of 5 out of 5, or CS_{WL4}=5/5, to the load wattage for workload 202 (WL4), and only assign a confidence rating of 1 out of 5, or CS_{WL5}=1/5, to the load wattage for workload 204 (WL5).

The variability in the load wattage of a workload may be captured more accurately over a longer time period than over a shorter time period. In other words, wattage measurements taken over a longer time period may be more likely to capture variability events that may occur with respect to the load wattage of a workload than wattage measurements taken over a shorter time period. It some instances, the confidence ratings may be colloquially referred to as “stars”. For example, the confidence rating ratio of C_{SWL4}=5/5 may be referred to as 5 stars, or 5 out of 5 stars. Moreover, the measurement durations described above are illustrative, and that the time interval to obtain load wattage measurements may vary in other embodiments (e.g., a day, a week, a month, etc).

Further, the specific confidence rating ratios, e.g., C_{SWL4}=5/5 and C_{SWL5}=1/5, are merely illustrative, and the confidence rating ratios for each of the load wattage may be based on any numerical scale, as long as the confidence rating ratios proportionally represent the comparative time or measurement frequency-based confidence ratings for load wattages of different workloads.

The load balance application 118 may further make determinations regarding the transfer of workloads based on a combination of the confidence ratings and load wattages of different workloads. For example, but not as a limitation, the server 108 shown in FIG. 2 may have a total wattage capacity of 300 watts. Moreover, the server 108 may be running a workload 116 (WL3) that consumes a load wattage of 225 watts. Thus, since both workload 202 (WL4) and workload 204 (WL5) have a load wattage of 50 watts, both may be qualified for transfer to the server 108.

However, the load balance application 118 may determine that the workload 202 (WL4) running on the server 104 may be preferentially transferred to the server 108, while the workload 204 (WL5) running on the server 106 should remain in place. The load application 118 may make this transfer decision based on the fact that the confidence rating for the workload 202 (WL4) load wattage, or CS_{WL4}=5/5, is higher than the confidence rating for the workload 204 (WL5) load wattage, or CS_{WL5}=1/5. In this way, there is a less likelihood that the transferred workload e.g., workload 202 (WL2) and the workload 116 (WL3) may exceed the total wattage capacity of the server 108 due to variability in the load wattage of the transferred workload over time.

In at least some embodiments, so long as the total load capacity of an accepting server (e.g., server 108) is able to accommodate the possible workload to be transferred, the load balance application 118 does not take load wattage into account when making transfer decisions based on the confidence ratings. Thus, even if the example described above is modified so that the load wattage of the workload 204 (WL5) is 40 watts instead of 50 watts, the load balance application 118 may nevertheless transfer the workload 202 (WL4) with the load wattage of 50 watts to the server 108 rather than the workload 204 (WL5).

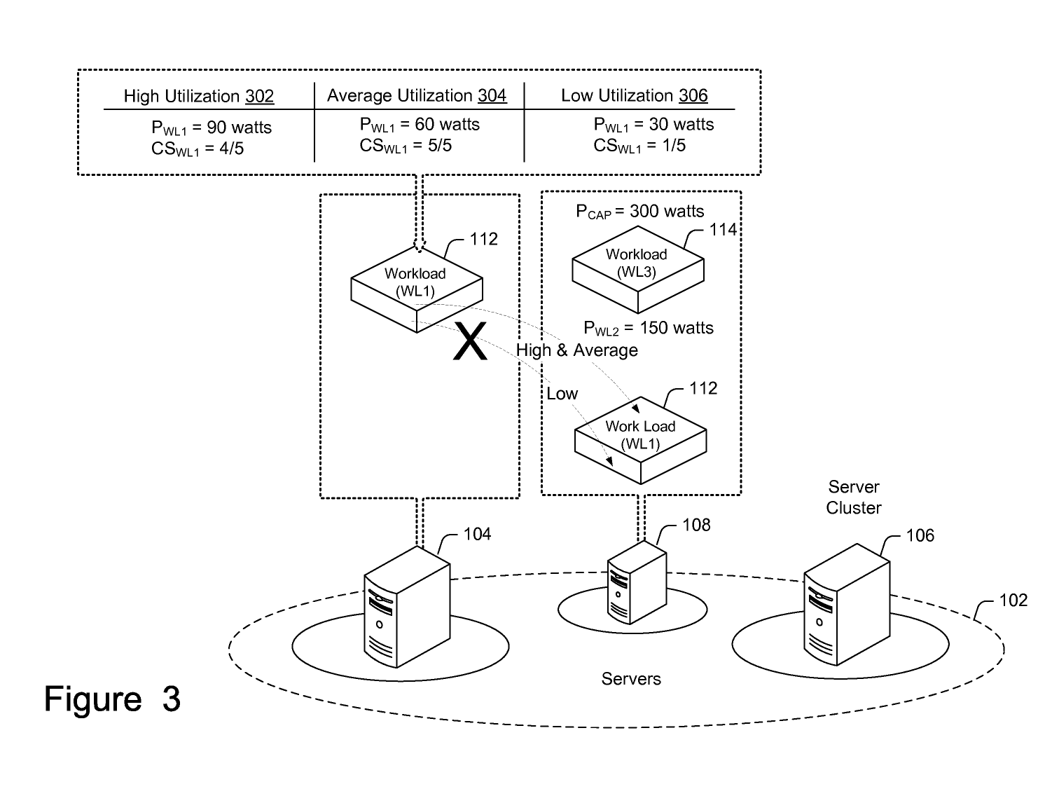

FIG. 3 is a block diagram that illustrates exemplary utilization state classification for determining energy consumption of a workload on a server, in accordance with various embodiments of energy use profiling for workload transfer. The servers 104-108 of the server cluster 102 shown may be same as described in FIG. 1.

In various embodiments, the load balance application 118 (FIG. 1) may assign confidence ratings, as described in FIG. 2, to discrete time periods, or utilization states, to adapt to the cyclic variability in the load wattages and confidence ratings of workloads. In such embodiments, the load balance application 118 may further transfer the workload that is in a particular utilization from a first server to a second server provided that a confidence rating of the workload in the particular utilization state meets a predetermined threshold.

For example, but not as a limitation, the load balance application 118 may obtain a plurality of load wattages and corresponding confidence ratings for the workload 112 (WL1). In this example, the load balance application 118 may derive a first load wattage and a first corresponding confidence rating for a high utilization state 302. Likewise, the load balance application 118 may further derive a second load wattage and a corresponding second confidence rating for an average utilization state 304, and a third load wattage and a third corresponding confidence rating for a low utilization state 306.

In such an example, the load balance application 118 may be configured to recognize approximately 80-100% utilization of a central processing unit (CPU) in the server 104 as falling into the high utilization states 302. Likewise, the load balance application 118 may be configured to recognize approximately 50-79% utilization of the CPU in the server 104 as falling into an average utilization state 304. Further, the load balance application 118 may recognize approximately 1-49% utilization CPU in the server 104 as falling to a low utilization state 306.

Moreover, each of the utilization states may correspond to one specific time duration. For example, but not as limitation, the workload 112 (WL1) may be a SQL database application. In such an example, as shown in FIG. 3, the load balance application 118 may determine that the workload 112 (WL1) is in the high utilization state 302 during daytime hours (e.g., 8:00 a.m.-4:00 p.m.), with a load wattage of 90 watts, and a corresponding confidence rating of 4/5.

Further, the load balance application 118 may determine that the workload 112 (WL1) is in the average utilization state 304 during night hours (e.g., 4:00 p.m.-12:00 a.m.), with a load wattage of 60 watts, and a corresponding confidence rating of 5/5. Moreover, the load balance application 118 may also determine that the workload 112 (WL1) is in the low utilization state 306 during early morning hours (e.g., 12:00 a.m.-8:00 a.m.), with a load wattage of 30 watts, and a corresponding confidence rating of 1/5.

In such embodiments, the load balance application 118 may transfer the workload 112 (WL1) from the server 104 to the server 108 when the workload 112 (WL1) is in the high utilization state 302 and the average utilization state 304, as the respective confidence ratings, CS_{WL1}=4/5 and CS_{WL1}=5/5 of, the server 104 during those utilization states may be equal to or above a predetermined confidence rating threshold demanded by the server 108. However, the load balance application 118 may not transfer the workload 112 (WL1) from the server 104 to the server 108 when the workload is in the low utilization state 306, as the corresponding confidence rating of CS_{WL1}=1/5 is below the predetermined threshold demanded by the server 108.

While the derivation of load wattage and the assignment of confidence ratings with respect to discrete time periods, or utilization states, have been described with respect to utilization states 304-306, the utilization states 304-306 are illustrative rather than limiting. In other embodiments, the load balance application 118 may derive load wattage and assign confidence ratings for workloads using any number of utilization states, as long as such use of utilization states provide better “resolution” of load wattage patterns for workloads and better analysis of the cyclic variability in the load wattage patterns. For example, but not as a limitation, a plurality of utilization states may be used to ascertain load wattages and confidence ratings for a workload over different time intervals, such as a week, a month, a year, etc.

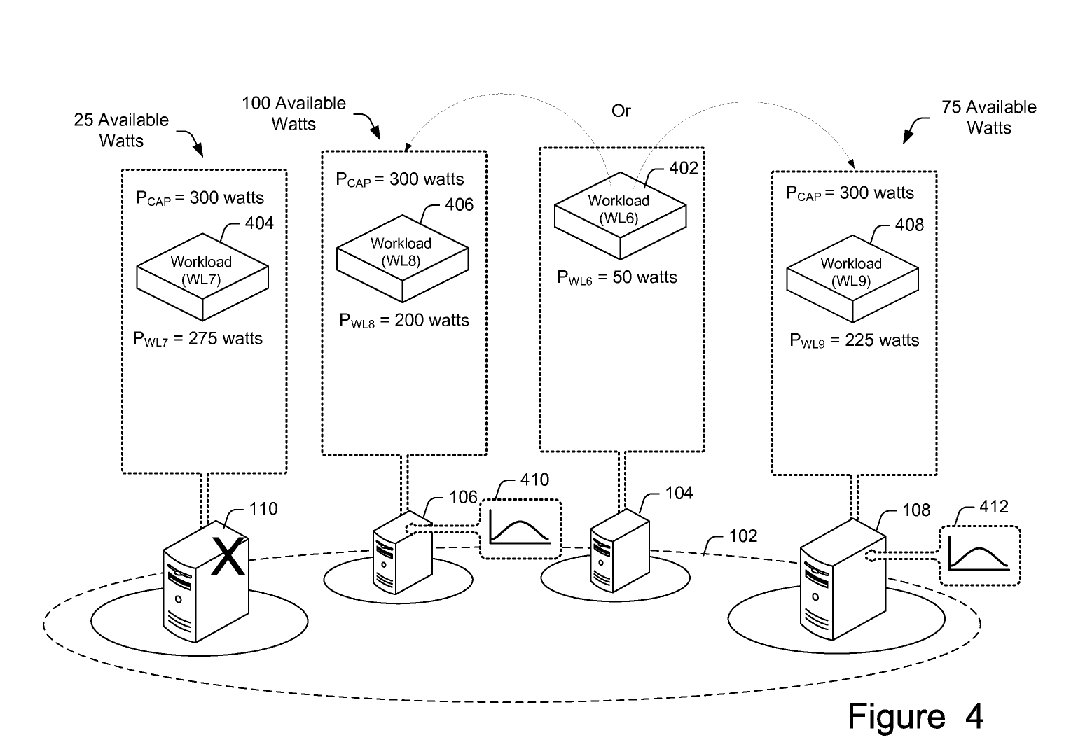

FIG. 4 is a block diagram that illustrates the use of exemplary metrics of a plurality of candidate servers to select a candidate server to accept a transfer workload, in accordance with various embodiments of energy use profiling for workload transfer. The servers 104-110 of the server cluster 102 shown may be same as described in FIG. 1.

As shown, the load balance application 118 may be in the process of selecting a server to accept a transfer a workload 402 (WL6) from the server 104, so that the server 104 may be powered down to conserve energy. The workload 402 (WL6) may have a load wattage of 50 watts. Thus, of the servers 106-110, server 110 may be unable to accommodate workload 402 (WL6) because the available wattage capacity of the server 110 is only approximately 25 watts as it is running a workload 404 (WL7) that consumes 275 watts of the total 300 watt capacity.

However, both servers 106 and 108 may be viable candidate servers to receive a transfer of the workload 402 (WL6). The server 106 may have an available wattage of 100 watts, as the server 106 is running a workload 406 (WL8) that consumes 200 watts of the server's 300 watt available capacity. The server 108 may have an available wattage of 75 watts, as the server 108 is running a workload 408 (WL9) that consumes 225 watts of the server's 300 watt available capacity.

In various embodiments, the load balance application 118 may select one of the servers 106 and 108 based on the metrics of each server, i.e., metrics 410 and 412, respectively. The metrics of each server may include the characteristics of each server that may affect the execution of a workload. In some embodiments, each of the metrics 410 and 412 may include the amount of available CPU capacity, the speed of the CPU, the amount of available memory, the amount of storage capacity, and/or other metrics.

Thus, the load balance application 118 may evaluate each of the candidate servers 106-108 to determine the candidate server that is best suited to accept the workload 402(WL6). For example, but not as a limitation, if the workload 402 (WL6) is a graphics application that needs intensive CPU processing, the load balance application 118 may pick one of the servers 106 and 108 that has the most amount of available CPU capacity. In another non-limiting example, the workload 402 (WL6) may be a memory-intensive database application. Thus, the load balance application 118 may pick one of the servers 106 and 108 that has the most amount of available memory. Accordingly, the load balance application may dynamically select the most suitable candidate server prior to a transfer based on the metrics of servers at that time and the needs of the workload that are to be transferred.

Moreover, it will be appreciated that while the selection of a candidate server is illustrated in FIG. 4 with respect to the servers 104-110, the load balance application 118 may select a candidate server from any plurality of candidate servers in the server cluster 102 (i.e., server with sufficient available wattage capacity) in other embodiments.

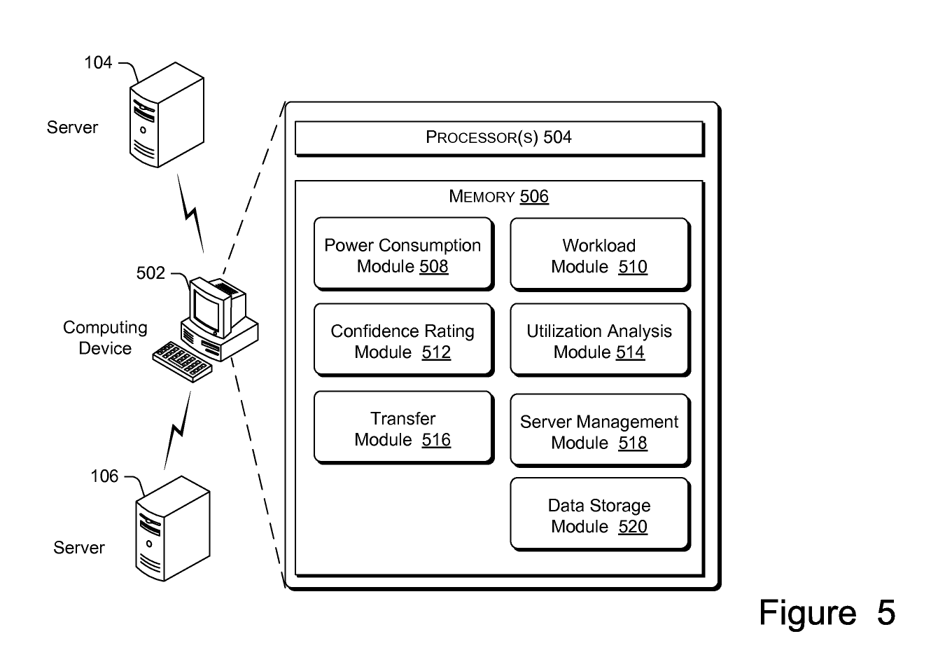

FIG. 5 shows a block diagram that illustrates selected components of the load balance application 118, in accordance with various embodiments of energy use profiling for workload transfer. The load balance application 118 may be implemented on a computing device 502 that includes one or more processors 504 and memory 506. The load balance application 118 may transfer workload between servers, such as the server 104 and the server 106 of the server cluster 102 (FIG. 1).

The memory 506 may include volatile and/or nonvolatile memory, removable and/or non-removable media implemented in any method or technology for storage of information, such as computer-readable instructions, data structures, program modules or other data. Such memory may include, but is not limited to, random accessory memory (RAM), read-only memory (ROM), electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and is accessible by a computer system.

The memory 506 may store program instructions. The program instructions, or modules, may include routines, programs, objects, components, and data structures that cause components of computer 502 to perform particular tasks or implement particular abstract data types. The selected program instructions may include a power consumption module 508, a workload module 510, a confidence rating module 512, a utilization analysis module 514, a transfer module 516, a server management module 518, and a database module 520.

The power monitor module 508 may detect the power consumption of each server, as described in FIG. 1, when no workload is running on any of the servers, such as the server 104. In various embodiments, the power monitor module 508 may detect the power consumption of a server by requesting the information from an operating system that is running on the server. In other embodiments, the power monitor module 508 may directly interface with a hardware component of a server to ascertain the power consumption.

The workload module 510 may use the detected power consumption from the power monitor module 508 to opportunistically and dynamically determine the load wattage of each workload that is running on each server. The workload module 510 may determine the load wattage of each workload without user input. In various embodiments, the workload module 510 may determine whether any workloads are running on each server by interacting with the operating system on each server. In this way, the workload module 510 may determine baseline wattage consumption for each server, overall wattage consumption for each server, and derive the load wattage of a workload running on each server from the difference between the baseline wattage consumption and the overall wattage consumption.

Moreover, the workload module 510 may also determine the load wattage of a first workload that is running on the server even when one or more additional workloads are running on the same server.

In various embodiments, if the workload module 510 is able to determine with a high degree of confidence that load wattages of such additional workloads are approximately constant over time, the workload module 510 may subtract the load wattages of one or more additional workloads from the overall wattage consumption during the calculation of the load wattage of the first workload.

In such embodiments, the workload module 510 may use a confidence rating of an additional workload to make such a confidence assessment. For example, but not as a limitation, an additional workload that is running simultaneously with the first workload may have a load wattage of 50 watts. Thus, if the workload module 510 determines that the confidence rating of the additional workload meets a threshold, such as above 4/5 (as described in FIG. 2), the workload module 510 may subtract the 50 watts from the overall wattage consumption of the server during the calculation of the load wattage of the first workload. In various embodiments, the workload module 510 may determine a plurality of load wattages that correspond to a plurality of utilization states for a workload.

The confidence rating module 512 may determine the confidence rating for the obtained load wattage of each workload. In some embodiments, the confidence rating module 512 may make the confidence rating determination based on the number of historical wattage measurements obtained, as described in FIG. 2. In other embodiments, the confidence rating module 512 may make the confidence rating determination based on the length of the time period during which wattage measurements were obtained, as further described in FIG. 2. In various embodiments, the confidence rating module 512 may determine confidence ratings of the workload for a plurality of utilization states.

The utilization analysis module 514 may divide the execution of a workload on a server into a plurality of utilization states. In some embodiments, the utilization state module 514 may use machine learning tools to ascertain the running patterns of a workload on a server, and divide a running pattern into a plurality of utilization states based on the cyclic variability in the execution of the workload. In this way, the utilization analysis module 510 may divide the execution of a workload according to a plurality of time intervals, or utilization states, so that the workload module 510 and the confidence rating module 514 may obtain a load wattage and corresponding confidence rating of a workload for each utilization state.

The transfer module 516 may transfer a workload from a first server to a second server. In some embodiments, the transfer module 516 may make the transfer when the transfer would not result in the total load wattages on the second server exceeding a total load capacity. In other embodiments, the transfer module 516 may make the transfer when the transfer would not result in the total load wattages on the second server exceeding a modified total load capacity. In at least one embodiment, the modified load capacity may be the total load capacity of the second server minus some predetermined buffer wattage e.g., 5-10% of the overall wattage capacity of the second server.

In additional embodiments, as described in FIG. 3, the transfer module 516 may also base a decision to transfer on whether a corresponding confidence rating of the load wattage for the workload meets a predetermined confidence rating threshold. In further embodiments, when multiple candidate servers are available to accept the transfer of a workload, the transfer module 516 may use the metrics of the servers to select one of the servers, as further described above with respect to FIG. 4. In various embodiments, the transfer module 516 may include a mechanism that transfers workload between servers. The workload that is transferred may include a virtual machine (VM) or a virtual hard disk (VHD).

The transfer module 516 may also transfer a workload from the second server back to the first server or, in the alternative, to a third server when the transfer module 516 determines or forecasts that a available wattage capacity on the seconds server is no longer sufficient to run the workload. In some embodiments, the transfer module 516 may consider the available wattage of the second server to be insufficient when the available wattage is less than the load wattage of the workload. In other embodiments, the transfer module 516 may consider the available wattage of the second server to be insufficient when the available wattage minus a predetermined buffer wattage (e.g., 5-10% of the overall wattage capacity of the second server) is less than the load wattage of the workload.

The server management module 518 may power down a server after a workload has been transferred away from the server. In some embodiments, the server management module 518 may place the first server in a suspended state, so that the first server may quickly resume an active state without rebooting. In other embodiments, the server management module 518 may bring a server out of a suspended state to resume the processing of a workload when the server that received the transferred workload can no longer run the workload. In various embodiments, the server management module 518 may suspend and resume a server by providing corresponding commands to the server.

The data storage module 520 may be configured to store data in a portion of memory 506 (e.g., a database). In various embodiments, the data storage module 520 may be configured to store data generated by the various modules of the load balance application 118. For example, but not as a limitation, the data storage module 520 may store the identities and configuration of the servers, the baseline wattage consumption of the servers, the load wattage histories of the workloads, the load wattages of the workloads at different utilization states, the confidence ratings that corresponds to the load wattages, confidence rating thresholds, as well as other data for the operation of the load balance application 118.

In alternative embodiments, the load balance application 118 may be further implemented on one of the servers in the server cluster 102 (FIG. 1), such as the server 106.

### Exemplary Processes

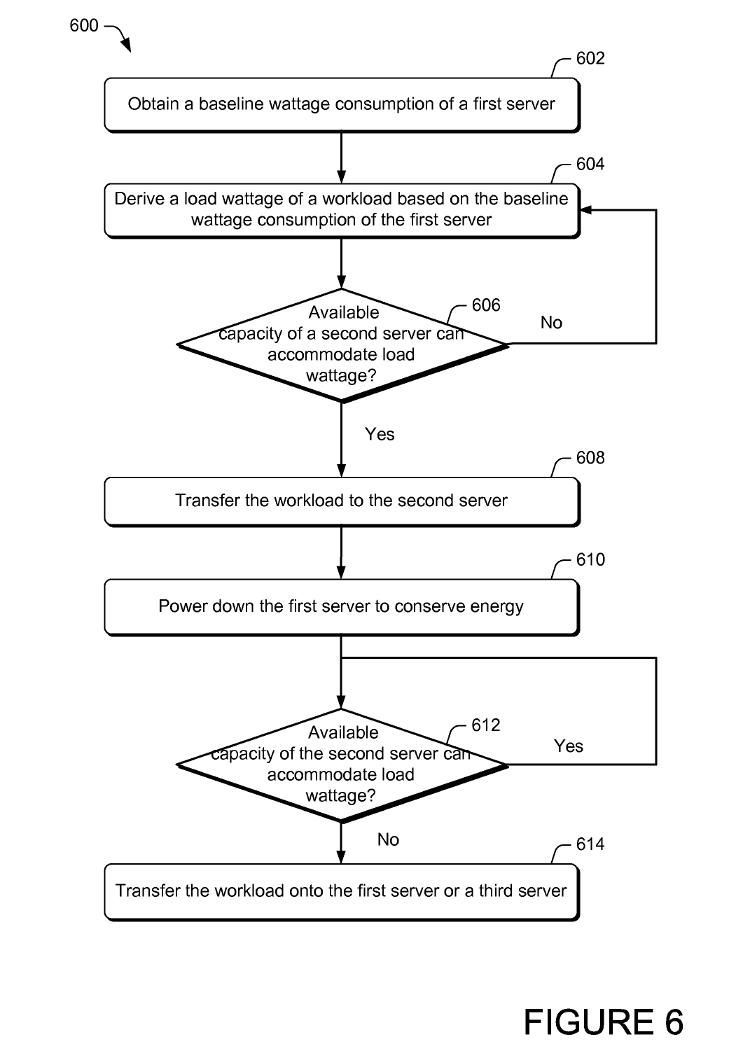

FIGS. 6-8 describes various exemplary processes for implementing energy profiling to facilitate workload transfers. The order in which the operations are described in each exemplary process is not intended to be construed as a limitation, and any number of the described blocks can be combined in any order and/or in parallel to implement each process. Moreover, the blocks in the FIGS. 6-8 may be operations that can be implemented in hardware, software, and a combination thereof. In the context of software, the blocks represent computer-executable instructions that, when executed by one or more processors, cause one or more processors to perform the recited operations. Generally, computer-executable instructions include routines, programs, objects, components, data structures, and the like that cause the particular functions to be performed or particular abstract data types to be implemented.

FIG. 6 shows a flow diagram illustrating an exemplary process 600 for transferring a workload from a first server to a second server based on determined workload energy consumption, in accordance with various embodiments.

At block 602, the load balance application 118 may obtain a baseline wattage consumption of a first server, such as the server 104 (FIG. 1). In various embodiments, the load balance application 118 may obtain the baseline wattage from an operating system or hardware of the first server.

At block 604, the load balance application 118 may derive a load wattage of a workload, such as workload 112 (WL1), based on the baseline wattage consumption of the first server. The load wattage may be derived as a difference between an overall wattage consumption of the first server and the baseline wattage consumption of the first server. In various embodiments, the load balance application 118 may derive the load wattage dynamically and opportunistically.

At decision block 606, the load balance application 118 may determine whether an available wattage capacity of the second server, such as the server 108, is sufficient to accommodate the load wattage of the workload, i.e., larger than the load wattage of the workload. In some embodiments, the available wattage capacity of the second server is the difference between the overall wattage capacity and the load wattage of any workload that is already running on the second server. In other embodiments, the available wattage capacity of the second server is the difference between the overall wattage capacity and the load wattage of any workload that is already running on the second server combined with a buffer wattage.

If the available wattage capacity of the second server is not sufficient to accommodate the load wattage of the workload (“no” at decision block 606), the process 600 may loop back to block 604, at which point the load balance application 118 may continuously derive the load wattage of the workload for determining whether the workload may be transferred.

However, if the available wattage capacity of the second server is sufficient to accommodate the load wattage of the workload (“yes” at decision block 606), the process 600 may proceed to block 608.

At block 608, the load balance application 118 may transfer the workload from the first server to the second server. In various embodiments, the load balance application 118 may transfer a workload that is one of a virtual machine (VM) or a virtual hard disk (VHD).

At block 610, the load balance application 118 may power down the first server to conserve energy. In various embodiments, the load balance application 118 may place the first server in a suspended state, so that the first server may quickly resume an active state without rebooting.

At decision block 612, the load balance application 118 may continuously determine whether the available wattage of the second server is sufficient to accommodate the load wattage of the workload. In some embodiments, the available wattage of the second server may be considered insufficient when the available wattage is less than the load wattage of the workload. In other embodiments, the available wattage of the second server may be considered insufficient when the available wattage minus a predetermined buffer wattage (e.g., 5-10% of the overall wattage capacity of the second server) is less than the load wattage of the workload.

In some embodiments, the load balance application 118 may use the load wattage histories of the workloads to make such determination. For example, but not as a limitation, the load balance application 118 may determine, based on a load wattage history of a workload transferred to the second server, that the load wattage may be expected to increase at the end of a month. Consequently, the load balance application 118 may determine that the available wattage capacity is insufficient at that time. In another example, the load balance application 118 may determine that the available wattage of the second server may be insufficient at some point as the load wattage of one or more non-transferred workloads on the second server are expected to increase at that time. In this way, load balance application 118 may forecast a future wattage insufficiency and plan a future transfer of the workload based on the forecast.

Thus, if the load balance application 118 determines that the available wattage capacity of the second server is sufficient to accommodate the load wattage of the workload (“yes” at decision block 612), the process 600 may loop back so that the load balance application 118 may further monitor the load wattage of the workload to determine whether the workload needs to be transferred.

However, if the available wattage capacity of the second server is not sufficient to accommodate the load wattage of the workload (“no” at decision block 612), the process 600 may proceed to block 614.

At block 614, the load balance application 118 may transfer the workload from the second server to the first server if the first server has sufficient available wattage capacity at the time the transfer is needed. However, when the first server has insufficient available wattage capacity at the time the transfer is needed, the load balance application 118 may transfer the workload to a third server with sufficient available wattage capacity.

The load balance application 118 may implement the process 600 for a plurality of different utilization states.

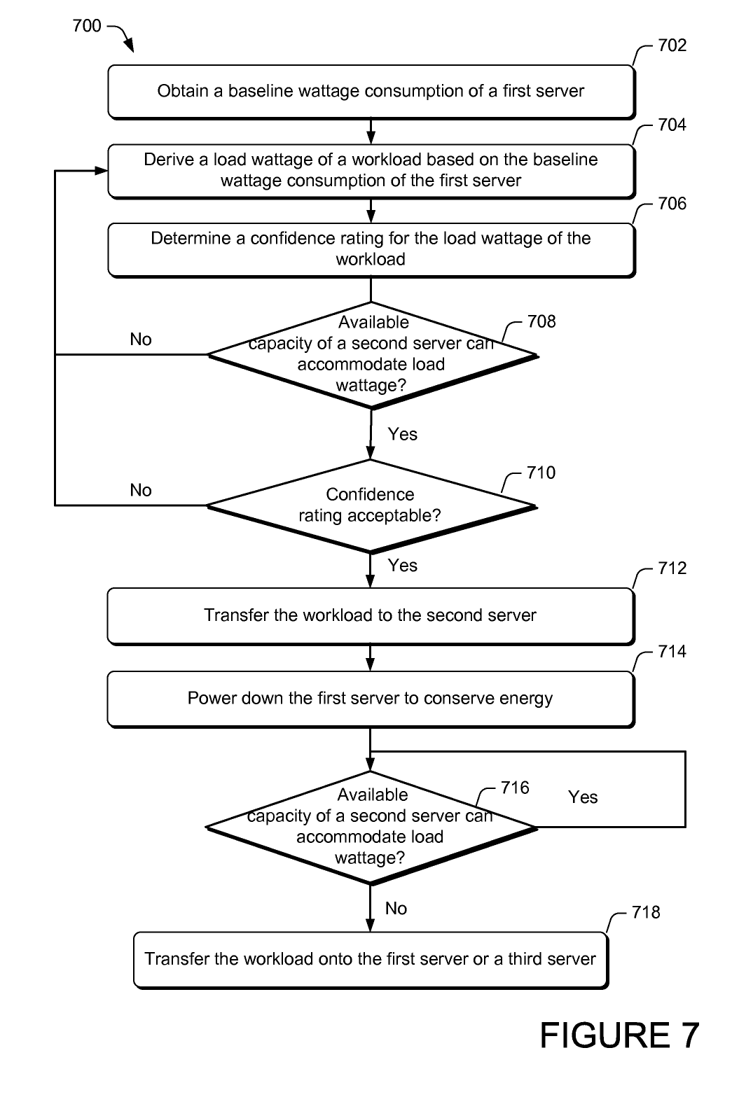

FIG. 7 shows a flow diagram illustrating an exemplary process 700 for transferring a workload from a first server to a second server based on determined workload energy consumption and related confidence rating, in accordance with various embodiments of energy use profiling for workload transfer.

At block 702, the load balance application 118 may obtain a baseline wattage consumption of a first server, such as the server 104 (FIG. 1). In various embodiments, the load balance application 118 may obtain the baseline wattage from an operating system or hardware of the first server.

At block 704, the load balance application 118 may derive a load wattage of a workload, such as workload 112 (WL1), that is running on the first server based on the baseline wattage consumption of the first server. The load wattage may be derived as a difference between an overall wattage consumption of the first server and the baseline wattage consumption of the first server. In various embodiments, the load balance application 118 may derive the load wattage dynamically and opportunistically.

At block 706, the load balance application 118 may determine a confidence rating for the derived load wattage of the workload. In some embodiments, the load balance application 118 may make the confidence rating determination based on the number of historical wattage measurements obtained. In other embodiments, the load balance application 118 may make the confidence rating determination based on the length of the time period during which wattage measurements were obtained.

At block 708, the load balance application 118 may determine whether an available wattage capacity of the second server, such as the server 108, is sufficient to accommodate the load wattage of the workload, i.e., larger than the load wattage of the workload. In some embodiments, the available wattage capacity of the second server is the difference between the overall wattage capacity and the load wattage of any workload that is already running on the second server. In other embodiments, the available wattage capacity of the second server is the difference between the overall wattage capacity and the load wattage of any workload that is already running on the second server combined with additional buffer wattage.

If the available wattage capacity of the second server is not sufficient to accommodate the load wattage of the workload (“no” at decision block 708), the process 700 may loop back to block 704, at which point the load balance application 118 may continuously derive the load wattage of the workload for determining whether the workload may be transferred.

However, if the available wattage capacity of the second server is sufficient to accommodate the load wattage of the workload (“yes” at decision block 708), the process 700 may proceed to decision block 708.

At decision block 710, the load balance application 118 may determine whether the confidence rating of the workload is acceptable to the second server. In various embodiments, the load balance application 118 may compare the confidence rating of the workload to a confidence rating threshold that is predetermined for the second server. If the load balance application 118 determines that the confidence rating of the workload is not acceptable to the second server (“no” at decision block 710), the process 700 may loop back to block 704, at which point the load balance application 118 may continuously derive the load wattage and subsequently the corresponding confidence rating of the workload for determining whether the workload may be transferred.

However, if the available wattage capacity of the second server is sufficient to accommodate the load wattage of the workload (“yes” at decision block 710), the process 700 may proceed to block 712.

At block 712, the load balance application 118 may transfer the workload from the first server to the second server. In various embodiments, the load balance application 118 may transfer a workload that is one of a virtual machine (VM) or a virtual hard disk (VHD).

At block 714, the load balance application 118 may power down the first server to conserve energy. In various embodiments, the load balance application 118 may place the first server in a suspended state, so that the first server may quickly resume an active state without rebooting.

At decision block 716, the load balance application 118 may continuously determine whether the available wattage of the second server is sufficient to accommodate the load wattage of the workload. In some embodiments, the available wattage of the second server may be considered insufficient when the available wattage is less than the load wattage of the workload. In other embodiments, the available wattage of the second server may be considered insufficient when the available wattage minus a buffer wattage (e.g., 5-10% of the overall wattage capacity of the second server) is less than the load wattage of the workload.

In some embodiments, the load balance application 118 may use the load wattage histories of the workloads to make such determination. For example, but not as a limitation, the load balance application 118 may determine, based on a load wattage history of a workload transferred to the second server, that the load wattage may be expected to increase at the end of a month. Consequently, the load balance application 118 may determine at that time that the available wattage capacity is insufficient at that time. In another example, the load balance application 118 may determine that the available wattage of the second server may be insufficient at some point as the load wattage of one or more non-transferred workloads on the second server are expected to increase at that time.

Thus, if the load balance application 118 determines that the available wattage capacity of the second server is sufficient to accommodate the load wattage of the workload (“yes” at decision block 716), the process 700 may loop back so that the load balance application 118 may further monitor the load wattage of the workload to determine whether the workload needs to be transferred.

However, if the available wattage capacity of the second server is not sufficient to accommodate the load wattage of the workload (“no” at decision block 716), the process 700 may proceed to block 718.

At block 718, the load balance application 118 may transfer the workload from the second server onto the first server if the first server has sufficient available wattage capacity at the time the transfer is needed. However, when the first server has insufficient available wattage capacity at the time the transfer is needed, the load balance application 118 may transfer the workload to a third server with sufficient available wattage capacity and a suitable confidence rating threshold. The load balance application 118 may further implement the process 700 for a plurality of different utilization states.

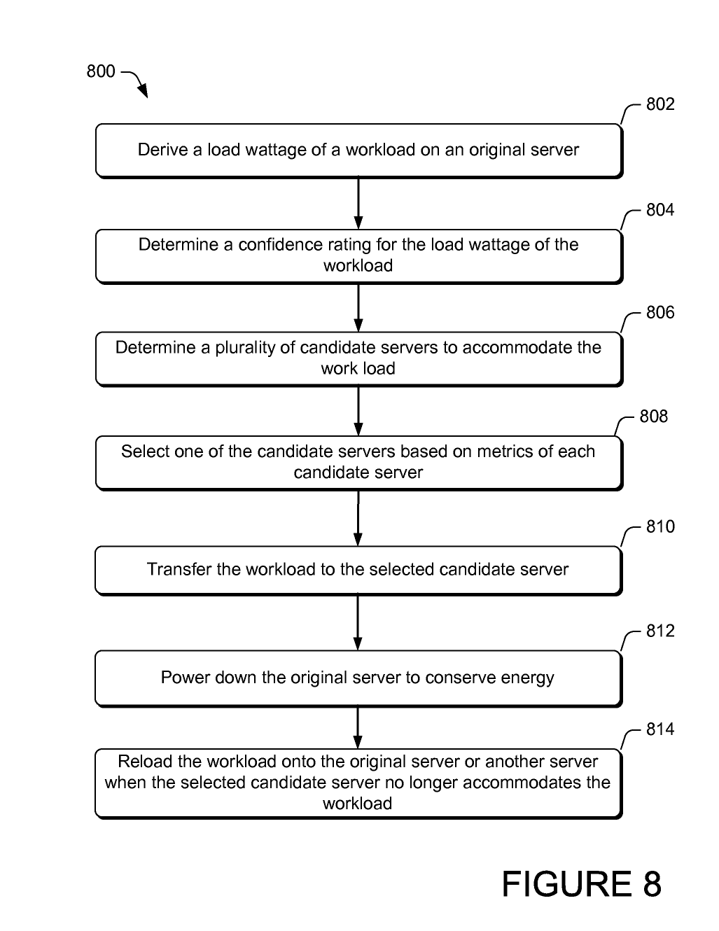

FIG. 8 shows a flow diagram illustrating an exemplary process 800 for transferring a workload from a first server to a second server that is selected based on performance metrics, in accordance with various embodiments of energy use profiling for workload transfer.

At block 802, the load balance application 118 may derive a load wattage of a workload that is running on an original server. The load balance application 118 may derive the load wattage dynamically and opportunistically. In various embodiments, load wattages may be derived for each of a plurality of utilization states.

At block 804, the load balance application 118 may determine a confidence rating for the load wattage of the workload. In some embodiments, the load balance application 118 may make the confidence rating determination based on the number of historical wattage measurements obtained. In other embodiments, the load balance application 118 may make the confidence rating determination based on the length of the time period during which wattage measurements were obtained.

At block 806, the load balance application 118 may determine a plurality of candidate servers that may accommodate the workload from the original server. The candidate servers may be part of a server cluster. In various embodiments, each of the candidate servers may have sufficient wattage capacity to accommodate the running of the workload, as well as a suitable confidence rating threshold that permits the acceptance of the workload.

At block 808, the load balance application 118 may select one of the candidate servers based on metrics of each candidate server. In various embodiments, the metrics of each server may include the characteristics that may affect the execution of a workload. In some embodiments, each of the metrics 410 and 412 may include the amount of available CPU capacity, the speed of the CPU, the amount of available memory, the amount of storage capacity, and/or other metrics. In at least one embodiment, the load balance application 118 may select a candidate server with metrics that are most beneficial to the execution of the workload.

At block 810, the load balance application 118 may transfer the workload from the original to the selected candidate server. In various embodiments, the load balance application 118 may transfer a workload that is one of a virtual machine (VM) or a virtual hard disk (VHD).

At block 812, the load balance application 118 may power down the original server to conserve energy. In various embodiments, the load balance application 118 may place the original server in a suspended state, so that the original server may quickly resume an active state without rebooting.

At block 814, the load balance application 118 may transfer the workload to the original server or another server when the selected candidate server no longer has the available wattage capacity to run the transferred workload. The load balance application 118 may transfer the workload to the original server if the original server has sufficient available wattage capacity at the time the transfer is needed. However, when the original server has insufficient available wattage capacity at the time the transfer is needed, the load balance application 118 may transfer the workload to another server with sufficient available wattage capacity and a suitable confidence rating threshold.

In some embodiments, the available wattage of the selected candidate server may be considered insufficient when the available wattage is less than the load wattage of the workload. In other embodiments, the available wattage of the selected candidate server may be considered insufficient when the available wattage minus a buffer wattage (e.g., 5-10% of the overall wattage capacity of the selected candidate server) is less than the load wattage of the workload. In this way, the workload may be transferred between servers to ensure that the workload is continuously executed.

### Exemplary Computing Device

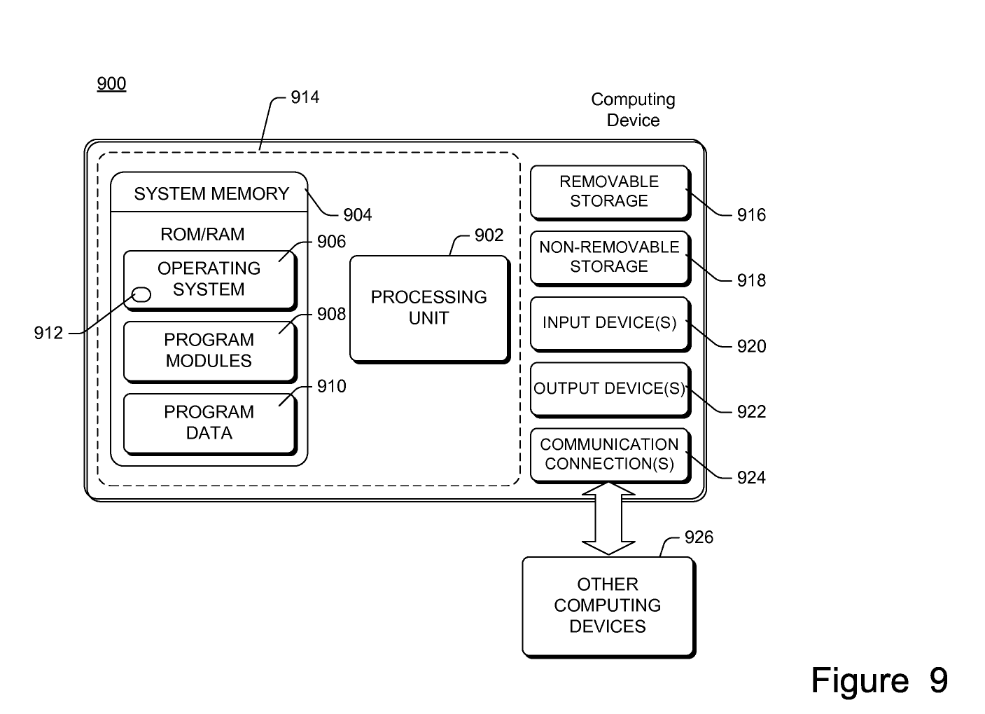

FIG. 9 illustrates a representative computing device 900 that may implement server energy profiling and workload transfers. For example, but not as a limitation, the computing device 900 may be part of a server as described in FIGS. 1-4. Moreover, the computing device 900 may also act as the computing device 502 described in FIG. 5. However, it will be readily appreciated that the techniques and mechanisms may be implemented in other computing devices, systems, and environments. The computing device 900 shown in FIG. 9 is only one example of a computing device and is not intended to suggest any limitation as to the scope of use or functionality of the computer and network architectures. Neither should the computing device 900 be interpreted as having any dependency or requirement relating to any one or combination of components illustrated in the example computing device.

In at least one configuration, computing device 900 typically includes at least one processing unit 902 and system memory 904. Depending on the exact configuration and type of computing device, system memory 904 may be volatile (such as RAM), non-volatile (such as ROM, flash memory, etc.) or some combination thereof. System memory 904 may include an operating system 906, one or more program modules 908, and may include program data 910. The operating system 906 includes a component-based framework 912 that supports components (including properties and events), objects, inheritance, polymorphism, reflection, and provides an object-oriented component-based application programming interface (API), such as, but by no means limited to, that of the .NET™ Framework manufactured by the Microsoft Corporation, Redmond, Wash. The computing device 900 is of a very basic configuration demarcated by a dashed line 914. Again, a terminal may have fewer components but will interact with a computing device that may have such a basic configuration.

Computing device 900 may have additional features or functionality. For example, computing device 900 may also include additional data storage devices (removable and/or non-removable) such as, for example, magnetic disks, optical disks, or tape. Such additional storage is illustrated in FIG. 9 by removable storage 916 and non-removable storage 918. Computer storage media may include volatile and nonvolatile, removable and non-removable media implemented in any method or technology for storage of information, such as computer readable instructions, data structures, program modules, or other data. System memory 904, removable storage 916 and non-removable storage 918 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by Computing device 900. Any such computer storage media may be part of device 900. Computing device 900 may also have input device(s) 920 such as keyboard, mouse, pen, voice input device, touch input device, etc. Output device(s) 922 such as a display, speakers, printer, etc. may also be included. These devices are well known in the art and are not discussed at length here.

Computing device 900 may also contain communication connections 924 that allow the device to communicate with other computing devices 926, such as over a network. These networks may include wired networks as well as wireless networks. Communication connections 924 are some examples of communication media. Communication media may typically be embodied by computer readable instructions, data structures, program modules, etc.

It is appreciated that the illustrated computing device 900 is only one example of a suitable device and is not intended to suggest any limitation as to the scope of use or functionality of the various embodiments described. Other well-known computing devices, systems, environments and/or configurations that may be suitable for use with the embodiments include, but are not limited to personal computers, server computers, hand-held or laptop devices, multiprocessor systems, microprocessor-base systems, set top boxes, game consoles, programmable consumer electronics, network PCs, minicomputers, mainframe computers, distributed computing environments that include any of the above systems or devices, and/or the like.

The transfer of workloads between the multiple servers, or load balance, during times of low energy consumption may enable the consolidation of multiple workloads and the powering down of one or more servers to conserve energy. In this way, the data center may realize significant energy savings and cost reduction during times of low workload demand.

### Conclusion

In closing, although the various embodiments have been described in language specific to structural features and/or methodological acts, it is to be understood that the subject matter defined in the appended representations is not necessarily limited to the specific features or acts described. Rather, the specific features and acts are disclosed as exemplary forms of implementing the claimed subject matter.

1. A computer readable medium storing computer-executable instructions that, when executed, cause one or more processors to perform acts comprising:
obtaining a baseline wattage of a first server;
deriving at least one load wattage of a workload using a difference between the baseline wattage consumption and an overall wattage consumption; and
transferring the workload to a second server when the at least one load wattage is less than an available wattage on the second server.

2. The computer readable medium of claim 1, further comprising an instruction that when executed, cause one or more processors to perform an act of powering down the first server following a transfer of the workload to the second server.

3. The computer readable medium of claim 1, further comprising an instruction that when executed, cause one or more processors to perform an act of transferring the workload onto the first server or a third server when the available wattage on the second server is less than the at least one load wattage of the workload.

4. The computer readable medium of claim 1, wherein the determining includes dynamically and opportunistically deriving the load wattage of the first server.

5. The computer readable medium of claim 1, wherein the deriving includes deriving a load wattage for each of a plurality of workload utilization states, and the transferring includes transferring the workload when the load wattage of the workload during one of the plurality of utilization state is less than an available wattage on the second server.

6. The computer readable medium of claim 5, wherein the plurality of utilization states includes a high utilization state that corresponds to approximately 80-100 percent utilization, an average utilization state that correspond to approximately 50-79 percent utilization, and a low utilization state that corresponds to approximately 1-49 percent utilization.

7. The computer readable medium of claim 1, wherein the deriving includes deriving the at least one load wattage of a workload by deriving an average value from a plurality of load wattage measurements obtained in a predetermined time period.

8. A computer readable medium storing computer-executable instructions that, when executed, cause one or more processors to perform acts comprising:
obtaining a baseline wattage of a first server;
deriving at least one load wattage of a workload using a difference between the baseline wattage consumption and an overall wattage consumption;
determining a confidence rating for the at least one load wattage of the workload;
providing a command to transfer the workload to a second server when the at least one load wattage is less than or equal to an available wattage on the second server and the confidence rating meets a minimal threshold; and
powering down the first server following a transfer of the workload to the second server.

9. The computer readable medium of claim 8, wherein the baseline wattage consumption includes an additional load wattage of another workload when the confidence rating of the additional load wattage is equal to or higher than a predetermined rating threshold.

10. The computer readable medium of claim 8, further comprising an instruction that when executed, cause one or more processors to perform an act of transferring the workload onto the first server when the available wattage on the second server is less than the at least one load wattage of the workload.

11. The computer readable medium of claim 8, further comprising an instruction that when executed, cause one or more processors to perform an act of transferring the workload onto the first server when the available wattage on the second server minus a buffer wattage is less than the at least one load wattage of the workload.

12. The computer readable medium of claim 8, wherein the deriving includes deriving a load wattage for each of a plurality of workload utilization states, and the providing includes providing a command to transfer the workload when the load wattage of the workload during one of the plurality of utilization state is less than or equal to an available wattage on the second server and the confidence level meets a minimal threshold.

13. The computer readable medium of claim 8, wherein deriving includes deriving the at least one load wattage of a workload by deriving an average value from a plurality of load wattage measurements obtained in a predetermined time period.

14. A computer readable medium storing computer-executable instructions that, when executed, cause one or more processors to perform acts comprising:
deriving at least one load wattage of a workload on an original server;
determining a plurality of candidate servers to accept the workload, each of the candidate servers having an available wattage that is greater than the at least one load wattage;
selecting one of the plurality of candidate servers based on the metrics of each candidate server; and
transferring the workload to the selected candidate server.

15. The computer readable medium of claim 14, wherein the selecting includes selecting one of the plurality of candidate servers having at least one of most memory availability, most data storage availability, and most CPU resource availability.

16. The computer readable medium of claim 14, further comprising an instruction that when executed, cause one or more processors to perform an act of powering down the original server following a transfer of the workload to the selected candidate server.

17. The computer readable medium of claim 14, further comprising an instruction that when executed, cause one or more processors to perform an act of transferring the workload onto the original server or another server when the available wattage on the selected candidate server is less than the at least one load wattage of the workload.

18. The computer readable medium of claim 14, wherein the work load includes a virtual machine (VM) or a virtual hard disk (VHD).

19. The computer readable medium of claim 14, wherein the deriving includes deriving a load wattage for each of a plurality of workload utilization states, and the transferring include transferring the workload when the load wattage of the workload during one of the plurality of utilization state is less than an available wattage on the selected candidate server and the confidence level meets a minimal threshold.

20. The computer readable medium of claim 14, further comprising an instruction that when executed, cause one or more processors to perform an act of deriving a confidence rating for the at least one load wattage of the workload, wherein the transferring includes transferring the workload when the confidence level meets a minimal threshold.
